(19) United States
(12) Patent Application Publication
(10) Pub. No.: US 2002/0120647 A1
(43) Pub. Date: Aug. 29, 2002

(54) Application data error correction support

(75) Inventor: Tomio Amano, Yokohama-shi (JP)

Correspondence Address: FERENCE & ASSOCIATES, 129 Oakhurst Road, Pittsburgh, PA, 15215, US

(73) Assignee: IBM Corporation, Armonk, NY (US)

(21) Appl. No.: 09/965,772

(22) Filed: Sep. 27, 2001

(30) Foreign Application Priority Data
Sep. 27, 2000 (JP) 2000-295007

(51) Int. Cl. G06F 17/24; G06F 17/21

(52) U.S. Cl. 707/501.1

(57) ABSTRACT

Detecting errors or incorrect conversions that tend to occur during the re-input of text in a markup description language used to write data or sentences is provided. A first computer comprises: a markup addition profile, which includes information used for replacing with tags a predetermined portion in XML application data; and an error prevention/detection/correction markup addition module, for replacing with tags, while referring to the markup addition profile, the predetermined portion of the application data, for generating and outputting application data that includes correction information. A second computer comprises: an error detection/correction module, for receiving the application data that includes correction information, for recognizing a tag set included in the data, and for detecting errors or incorrect conversions in the application data.

### CLAIM FOR PRIORITY

This application claims priority from Japanese Patent Application No. 2000-295007, filed on Sep. 27, 2000, and which is hereby incorporated by reference as if fully set forth herein.

### FIELD OF THE INVENTION

The present invention generally relates to a text data error correction support method, and in particular to a method for smoothly exchanging data or storing/employing data in an environment wherein a paper-based document/form and an electronic document/form coexist, or in an environment wherein it is not guaranteed that transmission of text information is ensured.

### BACKGROUND OF THE INVENTION

As a general-purpose description language for the electronic exchange of documents, SGML (Standard Generalized Markup Language) is a markup language used mainly for describing the structure of a document. Since with SGML a user can define the logical structure of documents, and can easily process and manage documents and data exchanged by computers, the SGML language is suitable for an application that enables the sharing of documents and data among multiple users. HTML (Hyper Text Markup Language), which is the description language used to create WWW (World Wide Web) pages for the Internet, uses a simplified SGML related language. With this language, the method used for the display of images or documents employs tags, character strings enclosed by angle brackets (< >), to simplify the description process. However, a problem has arisen in that the extension function of the SGML language is lost.

On the other hand, XML (Extensible Markup Language) has drawn attention as a format description language for the exchange and storage of electronic document/form data. XML, the next-generation HTML, permits the extension function of SGML to also be used on the Web. That is, when the structure of a document is changed to a DTD (Document Type Definition) file, the employment of a tag unique to an application, which is used for the designation of a display method or the addition of meaning to a character string in a document, can be extended.

XML has several superior characteristics. Especially worthy of notice is that one of the characteristics of XML data is that it is text that a person can read, and another is that in XML a tag is a self-descriptive expression and that data are used for identifying data. These characteristics provide a property called “fallback possibility” for data written on the XML base.

The “fallback possibility” property can be interpreted as being one of which it can be said, “it is nice when an application is used in a good environment, but a poor environment can be coped with in its own way”. Relative to the exchange and storage of XML data, a “good environment” is one wherein XML data received by a Web server or a mail server are seamlessly processed/stored by an application. Whereas a “poor environment” is one wherein, for example, an automatic data exchange mechanism is not provided, but replacement means are available, such as means by which a user can cut and paste XML tagged text received in mail and transmit the text to an application, or means by which a user can enter the contents of facsimile text (XML tagged text) at a keyword and transmit them to an application. For a binary data format, or a data format wherein only data values, such as a CSV (Comma Separated Value: a file format wherein data are enumerated by using commas to delimit the entries), are written, the development of an additional tool or knowledge that is not written as data (the arrangement order and positions of fields) is frequently required to provide the replacement means.

For an application using data description that possesses the “fallback possibility” property, the implementation and operation, at various levels, of a company/department system and a program module, which is a component of the application, are permitted. For a company/department that can not invest much in IT, even though it desires to participate in an electronic work flow, an operation whereby an internal process and an exchange with a succeeding stage of processed data are all performed manually and an operation whereby a less frequently issued request is handled manually are available. The meaning of the fallback possibility in the data description is highly important for an application, such as for a market place or a supply chain, that numerous differently sized independent companies participate in (the value of an application increases consonant with the addition of participating companies). Further, the XML data description is also effective for a situation wherein the system is incrementally developed or debugged.

However, from the viewpoint of the effective and easy performance of a fallback, XML data description presents several problems. One of them relates to the re-input of data described on paper. Theoretically, XML text printed on paper need only be keyed for the same contents as the original electronic data to be reproduced. However, in actuality, when there are a number of blanks that have not been visually identified, or when there is a character and a symbol having the same shape (e.g., a minus symbol and a hyphen), a problem has arisen in that there is a question as to which characters or symbols should be entered, and as a result, slightly different data may be entered. An application malfunction of this type does not make it difficult for persons to read and understand content; however, problems appear while processing, searching a database or examining a signature, for example, is being performed.

In addition, the labor required for a manual re-input is also a problem. For example, when an OCR (Optical Character Reader) is employed, printed characters can be read at an accuracy of 95% to 99%, if all operating conditions, such as the scanning resolution, are satisfactory. However, in order to detect all the possible 1% to 5% of errors, a human must examine all of the text that has been read. Although many OCR systems issue warnings for portions whereat the reading results are questionable, this does not mean that it is guaranteed that those areas for which no warnings were issued were read correctly. In addition, while to increase reading accuracy an OCR can perform context processing, during which a word dictionary is referred to for each character that is read, reading accuracy is considerably deteriorated if in target text a technical term is included that is not carried in the dictionary or in an XML tag. Depending on the manual labor and the time required for checking and correcting data that is re-entered, the activation of a scenario in which a fallback process, for which paper is used, for the transmission of XML data would be unrealistic.

Furthermore, the availability of a text base that a person can read, in order to understand data, is a required condition for providing a fallback possibility for XML; however, with this condition, a problem due to the exchange of data on the text base arises, i.e., a so-called incorrect character conversion occurs. For example, during the processing for the transmission of XML text via several systems (servers), the conversion of character code may occur between systems employing different encoding methods for non-English character code. No problem occurs so long as such conversion is always uniquely performed, but in actuality, conversion tables that differ in certain respects are used by individual vendors, as are a variety of versions. As a result, when UTF-8, a character coding scheme that can be used for all the characters produced using [JIS X 0221] and [Unicode 2.0], is used in a UTF-8 d Shift JIS d UTF-8 conversion, a phenomenon occurs wherein part of the derived character code differs from the original (an incorrect conversion). The same problem occurs when foreign characters (characters allocated in the private area of ISO 10646) are employed. In the above example, even when users who display or process data based on UTF-8 are parties to an agreement concerning the use of foreign characters code, correct foreign character code can not be transmitted without including a specification concerning the Shift JIS code into which an intermediary has converted the original code, and concerning the code in the UTF-8 to which the converted code should correspond. Further, for the exchange of data using the Internet, a system can not be designated for mounting by participants or by intermediaries, or originally can not be known. Thus, there is an ever-present probability that an incorrect conversion will occur. Similarly, relative to the re-entry of data printed on paper, even a partial variance from an original, due to an incorrect conversion, can prove fatal during a database search or a signature verification process.

Further, for an application employed to develop a business activity using a digital network, a definition of the properties of a fallback possibility is highly important because participation in the use of the network is achieved step by step, by making a small investment. Therefore, in order to more effectively use the fallback possibility for the exchange and storage of XML data, the above problems must be resolved.

A need therefore exists to prevent errors or incorrect conversions that tend to occur during the re-input of text employing a markup description language, used to write data or sentences, or to detect and correct errors and incorrectly converted characters. A need also exists for a general-purpose program module that performs the addition of description and detection/correction for an error without depending on the logic of an application. There is also further need for providing application data that can follow the context processing performed by an OCR for special terms, such as the latest technical terms, jargon and proper nouns.

### SUMMARY OF THE INVENTION

In accordance with the present invention, errors and incorrect conversions can be detected that tend to occur during the re-input of text that is written in a description language for which markups are used to describe data or sentences.

The present invention provides an error correction support method, for application data written in a markup description language, such as XML (Extensible Markup Language), comprises the steps of: defining a tag set to prevent errors or incorrect character conversions that occur frequently during the re-input of text; and using a tag set to add rewritten information to a predetermined portion of the application data.

The tag set is defined for at least one of a character in the same shape, a similar character, a space or a character having a complicated shape (a character whose shape is so complicated that an image appears solid when using a low-resolution device, such as a facsimile machine). Thus, it is preferable when characters are printed on paper, because errors can be reduced for characters that visually appear ambiguous.

According to the invention, an error correction support method comprises the steps of: selecting, from elements of application data, a text portion that needs error correction support; enclosing the selected text portion using predetermined tags; and writing correction code, which is based on a predetermined algorithm, in the text portion enclosed by the predetermined tags.

The correction code is calculated for a character string that represents an attribute value or an attribute name, and is written using a predetermined attribute for the description of an error code.

Further, according to the invention, an error correction support method comprises the steps of: selecting, from elements of application data, character strings that require error correction support; generating, for the selected character strings, error correction codes that are is based on a predetermined algorithm; and writing the error correction codes as nodes for the application data.

The error correction codes are generated for all multiple character strings that are selected, and are added after predetermined elements of the application data have been written. With this arrangement, a message, “data thereafter constitute correction information”, can be collectively written for the data, and application data can be provided that users can easily read.

An error correction support method comprises the steps of: sorting, into predetermined attribute types, words in application data that may constitute barriers in context processes, i.e., words that, if present, probably will cause the context processes not to function well; writing the attribute types to the application data using a predetermined tag set; and transmitting or storing the application data with which the attribute types are included. A “word that may constitute a barrier in the context process” is at the least one of a set comprising proper nouns, alphabetic abbreviations, tag names, keywords that appear as element values, attribute names, keywords that appear as attribute values.

Further, according to the invention, a computer system, which generates application data in a markup description language, comprises: a markup addition profile, which includes information used for replacing a predetermined portion of the application data with tags and/or information for calculating error detection/correction code for the predetermined portion; a markup addition module, for replacing, by referring to the markup addition profile, the predetermined portion with tags, and/or calculating the error detection/correction code for the predetermined portion, and for adding to the application data, to generate application data using correction information, the tags and/or the error detection/correction code; and an outputter which outputs the application data with correction information that is obtained by the markup addition module.

The markup addition profile includes information used to insert the error detection/correction code into the application data, or information used to add the error detection/correction code as an annotation at the end of the application data.

From another viewpoint, a computer system according to the invention comprises: an inputter which enters application data with replacement information in a predetermined text portion that can be replaced by tags; a recognizer which recognizes the replacement information included in the application data that is entered by the inputter; and an error detector/corrector which replaces text information for the expression of the tags of the replacement information that is recognized by the recognizer.

In addition, according to the invention, a computer system comprises: an inputter which enters application data, including correction code generated for a predetermined text portion; a recognizer which recognizes the correction code, entered by the inputter, that is included in the application data; and an error detector/corrector which calculates the correction code recognized by the recognizer and which compares the correction code with a text portion, wherein, when the correction code does not match the text portion, the error detector/corrector determines whether automatic correction is possible, and wherein, when the automatic correction is determined to be possible, the error detector/corrector, based on the correction code, corrects the text portion and outputs the resultant application data.

A computer system comprises: an inputter which input text information from a paper-based document or form; a context process module which compares a word dictionary and individual character recognition results obtained from the text information, and which detects or corrects an error; and a word information recognizer for using tags input with the text information to recognize word information, such as technical terms and XML tags, that are not included in the word dictionary, wherein the word information is provided to the context process module to improve the reading accuracy of an OCR.

A computer system comprises: a selector which selects from application data, before the application data is read by another computer system, a word that may constitute a barrier in a context process that, to detect and correct errors, compares characters to be recognized with entries in a word dictionary; a descriptor which uses tags to write error correction code for the word that is selected by the selector; and an outputter which adds to the application data the error correction code that is written by the descriptor and which outputs on paper, etc., the application data with the error correction code.

According to the invention, an application data provision system is provided wherein a second computer reads application data generated by a first computer using a markup language; wherein the first computer defines a tag set to detect an error or an incorrect character conversion that tends to occur when text is re-input at the second computer, adds the tag set to the application data, and outputs the resultant application data with correction information; and wherein the second computer receives the application data with the correction information, recognizes the tag set that is included in the application data, and detects and/or corrects an error or an incorrectly converted character in the application data. The application data may be output by the second computer in an environment wherein a paper-based document/form and an electronic document/form coexist, or an environment wherein it can not be guaranteed that the transmission of text information is ensured.

An application data provision system is provided wherein a first computer employs tags to write additional information concerning predetermined text, and outputs the additional information with application data; wherein a second computer includes a context process module for detecting and correcting error by comparing individual character recognition results with entries in a word dictionary; and wherein the second computer receives, from the first computer, the application data and the additional information provided as a paper-based document or form, and employs the additional information that is received to update the entries in the word dictionary of the context process module.

According to the invention, a storage medium is provided on which a computer stores a computer-readable program that permits the computer to perform: a process for defining a tag set to prevent errors and incorrect character conversions that tend to occur during the re-input of text that is included in application data written in a markup language, such as XML; and a process for adding, to a predetermined portion of application data, replacement information using the tag set and/or correction code based on a predetermined algorithm.

From another viewpoint, according to the invention, a storage medium is provided on which a computer stores a computer-readable program that permits the computer to perform: a process for recognizing a tag set that encloses replacement information, and/or a correction code, to prevent errors or incorrect character conversions that tend to occur during the re-input of text information that is included in application data written in a markup language; and a process for employing the tag set to replace predetermined text information in the application data. These storage media can be, for example, CD-ROMs. The program can be read by the CD-ROM reader of the computer, be stored on, for example, the hard disk of the computer, and be executed.

For a better understanding of the present invention, together with other and further features and advantages thereof, reference is made to the following description, taken in conjunction with the accompanying drawings, and the scope of the invention that will be pointed out in the appended claims.

### BRIEF DESCRIPTION OF THE DRAWINGS

FIG. 1 is a diagram showing an example replacement of target data according to one embodiment of the present invention.

FIG. 2 is a diagram showing an example preparation for an error correction code.

FIGS. 3A and 3B are diagrams for explaining an example wherein error correction information is inserted into text in an element.

FIGS. 4A to 4C are diagrams showing an example for the insertion of correction information using correction code description attributes according to the embodiment.

FIGS. 5A and 5B are diagrams showing an example wherein error correction information is added after the description of application data.

FIGS. 6A to 6C are diagrams showing example information to be provided for the context process module of an OCR system.

FIG. 7 is a diagram for explaining the general configuration of an error correction support system according to the embodiment.

FIG. 8 is a flowchart showing the processing performed by an error prevention/detection/correction markup addition module 13 at a first computer 10.

FIG. 9 is a flowchart showing the processing performed by an error detection/correction module 23 at a second computer 20.

FIG. 10 is a diagram showing an example wherein intermediate results are written on the XML base.

FIG. 11 is a flowchart showing an overview of processing performed for text using error detection/correction information.

FIG. 12 is a diagram showing example XML data for application example 1.

FIG. 13 is a diagram showing example XML data for application example 2.

FIG. 14 is a diagram showing example XML data for application example 3.

### DETAILED DESCRIPTION OF PREFERRED EMBODIMENTS

The preferred embodiment of the invention will now be described in detail while referring to the accompanying drawings. First, the markup for the prevention, detection and correction of an error according to the invention will be described in order to easily understand the error correction method of this embodiment. In this embodiment, an explanation will be given for three examples: (1) target data replacement; (2) insertion into/addition to target data of error detection/correction information; and (3) addition of information concerning target data contents.

(1) Target Data Replacement

This example covers the replacement, using a specific element, of a character that may be visually ambiguous when printed on paper. The target character is a character for which a blank, a character having the same shape or a similar character is present, or a character whose shape is so complicated that its image will appear solid when reproduced by a low-resolution device, such as a facsimile machine.

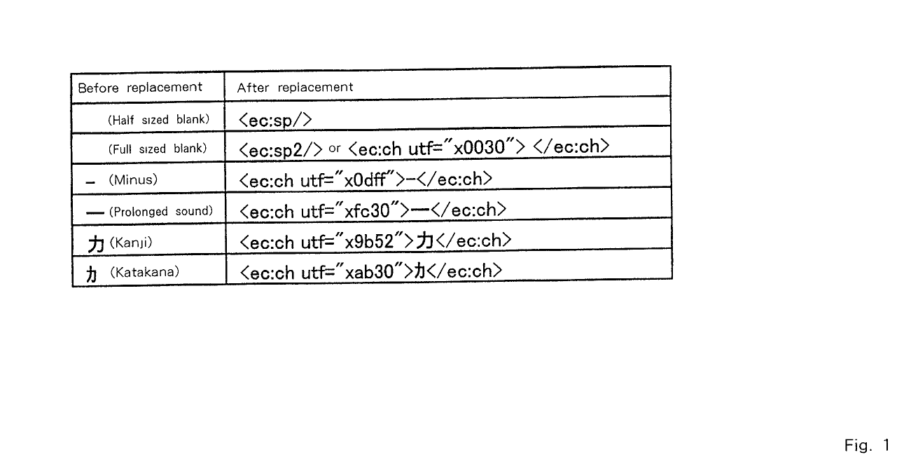

FIG. 1 is a diagram showing an example target data replacement for this embodiment. In this example, a half sized blank is replaced by <ec:sp/>, a full sized blank is replaced by <ec:sp2/> or <ec:ch utf=“x0030”> </ec:ch>, and “− (minus)”, “— (prolonged sound)”, “— (Chinese character, or kanji)” and ” [symbol] (katakana)” are replaced by predetermined character codes.

In this example, it is assumed that a user must re-input data printed on paper, or must re-read the data using an OCR. When the data is printed, it can not be ascertained whether there are two half sized blanks or one full sized blank, and characters that appear that have the same shape are also present. Further, there are characters having complicated shapes that appear solid when copied and can not be read by the OCR. In this embodiment, since these characters are replaced by character codes, even though their expressions are redundant, characters having similar shapes can be regarded as characters having different shapes and can be read in accordance with different codes. That is, in this embodiment, since target data is replaced with a predetermined code that uses alphanumeric characters, the OCR recognition ratio can be improved considerably, when compared with when Chinese characters are read.

(2) Insertion Into/addition to Target Data of Error Detection/correction Information

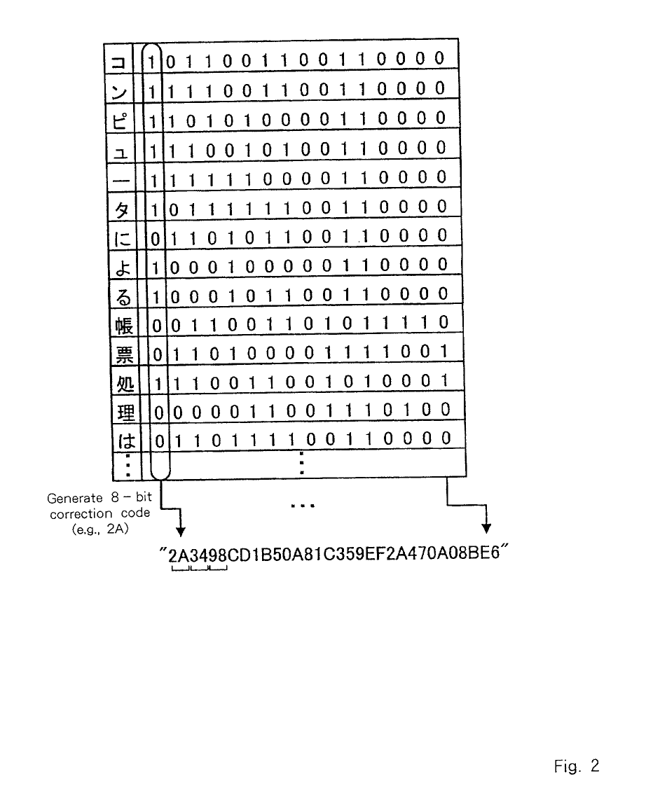

First, an explanation will be given for an example in which error correction information is inserted that is related to the text in an element. FIG. 2 is a diagram showing an example for the preparation of an error correction code. In this example, an error correction code is prepared for character string “form processing using a computer”. In this embodiment, the text portion of an element is enclosed by tags, and an error correction code is written that is generated by employing a conventional algorithm. For example, as is shown in FIG. 2, a bit string for each digit is assumed for a character string, each character of which is represented by 16 bits (e.g., a character coding scheme that can represent all the characters in the first 17 phases of UTF-16:[JIS X 0221] and [Unicode 2.0]), and a corresponding correction code is calculated. For example, a predetermined calculation is performed using a predetermined algorithm for a one bit string (e.g., bits enclosed in an oblong shape) for each character in FIG. 2, and a value of “2A” is obtained. When Hamming code (wherein a check bit is provided so that the number of digits that differs between two binary numbers is set to equal to or greater than a specific number, and an error can be corrected) is employed, correction codes of eight bits each are prepared for 32 characters, so that relative to a maximum 247 character string a recognition error for one character can be corrected.

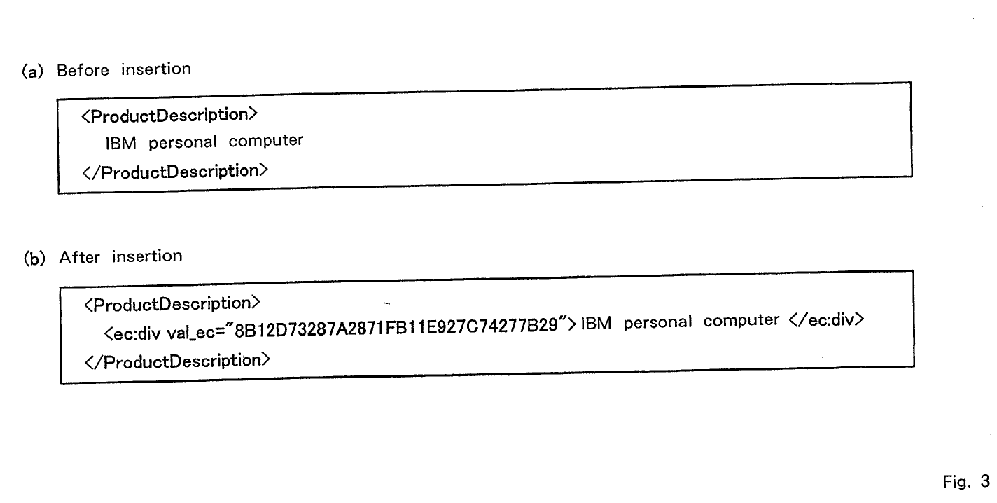

FIGS. 3A and 3B are diagrams for explaining an example wherein error correction information is inserted into the text of an element. The state prior to the insertion is shown in FIG. 3A, and the state following the insertion is shown in FIG. 3b. The value of attribute val_ec and the correction code “8B12 . . . 7B29” are calculated for the character string “IBM personal computer”, and are added to the character string. When the character string “IBM personal computer” is re-input, the same algorithm is employed to perform the same calculation for the code string. When the character string is re-input without any error, the same value as the correction code in FIG. 3B is obtained, but when in the re-input data an error occurs, a different value is output. The algorithm used for this calculation is one that provides the lowest probability that data will be matched incidentally. When an error occurs as a result of a re-input, in the correction code an “incorrect conversion” occurs, so that an error will be detected at statistically a high probability, i.e., the probability so high that can not be compared with the recognition ratio for OCR.

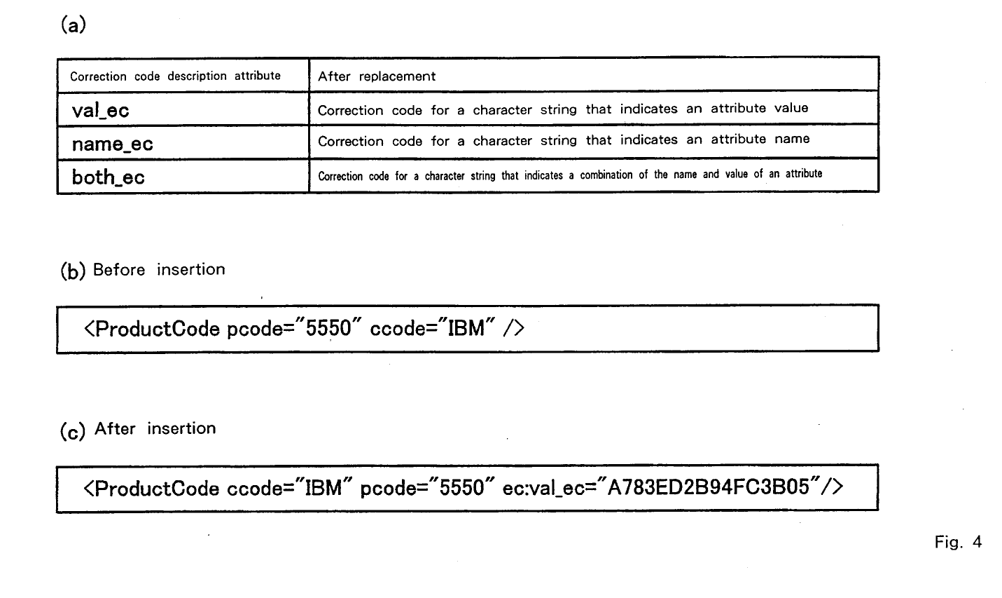

An explanation will now be given for an example in which error correction information is inserted concerning an attribute value and a name. FIGS. 4A to 4C are diagrams showing an example according to the embodiment for the insertion of correction information using a correction code description attribute. In FIG. 4A, an example correction code description attribute is shown, while in FIG. 4B, the state that existed before the insertion is shown, and in FIG. 4C, the state that existed following the insertion is shown.

In this example, the error correction code is calculated for an attribute name or a value, or for both of the character strings, and is written as the attribute value that is prepared for this embodiment. The relationship between the types of target character strings used for the correction code generation, and the correction code description attributes prepared for this embodiment is shown in FIG. 4A. For example, correction code description attribute “val_ec” is used to represent “correction code for a character string that serves as the attribute value”, “name_ec” is used to represent “correction code for a character string that serves as the attribute name”, and “both_ec” is used to represent “correction code for a character string that serves as the name and value of the attribute”.

When there are multiple target attributes, an error correction code is calculated for a character string wherein characters are linked, for example, in accordance with the alphabetical order of the attribute names. In the examples in FIGS. 4B and 4C, an error correction code for character string “IBM5550” is calculated and is represented by “val_ec”, and when “both_ec” is employed as the correction code description attribute, an error correction code for character string “ccodeIBMpcode5550” is calculated. That is, since an error could occur between the portion containing the name and the portion containing the value, it is meaningful for a character code to be written for a pair consisting of the name and the value.

In these examples, when correction information is inserted into a long character string, the locations of errors may not be identified, even though only a small amount of data is required for error correction, while when correction information is inserted into a short character string, the amount of data is increased, even though the location of the error can easily be identified. Therefore, while taking these factors into account, the length of a character string to be selected is determined. For example, since not many characters are required in the attribute information, it is preferable that the error correction code be collectively calculated.

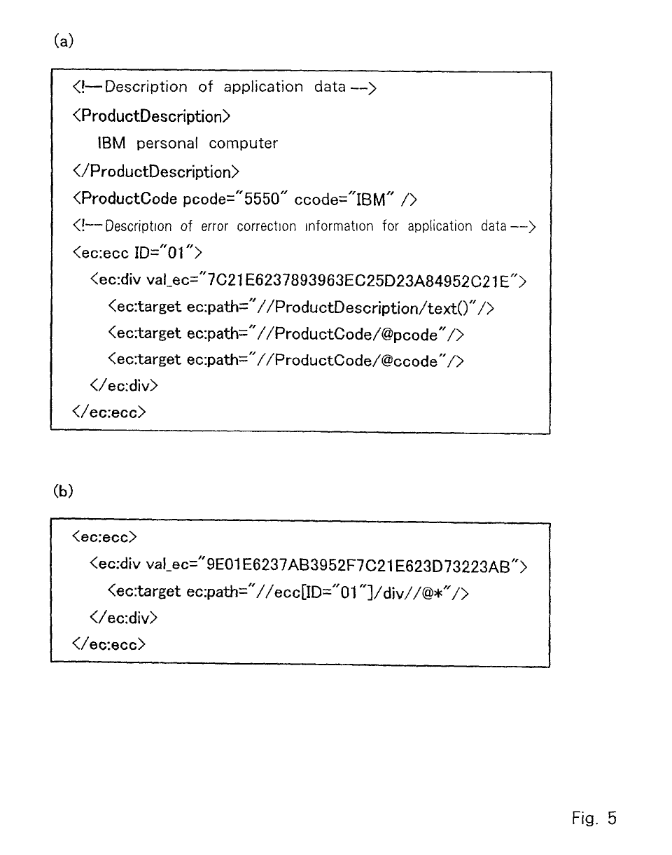

An explanation will now be given for an example wherein error correction information concerning multiple elements and attribute values is collectively written. FIGS. 5A and 5B are diagrams showing examples wherein error correction information is added following an application data description. In FIG. 5A, an error correction code for a predetermined character string is added as an annotation, and in FIG. 5B, an error correction code is added to the error correction code.

In FIGS. 3 and 4, the error correction information is written so that in the text it coexists with tags representing application data. However, by using the XPath, the error correction information can also be written as an annotation for the application data. For example, as is shown in FIG. 5a, the error correction information can be added following the description of the application data using the <ProductDescription> element and the <ProductCode> element that are used in FIGS. 3 and 4. That is, here, the error correction code is obtained for character string “IBM personal computer 5550IBM”. With this description when it is desired that the application be collectively written, the error correction information can be added, while clearly stating that hereinafter correction information will be written.

Contrariwise, as is shown in FIG. 5B, further error correction information can be added to the description in FIG. 5a. In the example in FIG. 5B, the values of the “val_ec” attribute and the “path” attribute in FIG. 5A are added as error correction codes to character strings that are linked in the order in which they appear. As is described above, when an XML markup is employed, in the same manner, the error correction code can be added as needed.

(3) Addition of Information Concerning Target Data Contents

When OCR is employed to input text, the context process can effectively, automatically detect and correct errors by comparing individual character recognition results with entries in a word dictionary. This context process is a process for improving reading accuracy by comparing individual character recognition results with entries in the word dictionary. That is, the recognition ratio can be increased by using both the character recognition results and the word dictionary. However, the context process will not function satisfactorily if proper nouns, technical terms and XML tags that are not entered in the OCR dictionary are included in the target text. In this embodiment, the information for a word that is not carried in the dictionary is written using tags that will be described later, and is provided for the context process module.

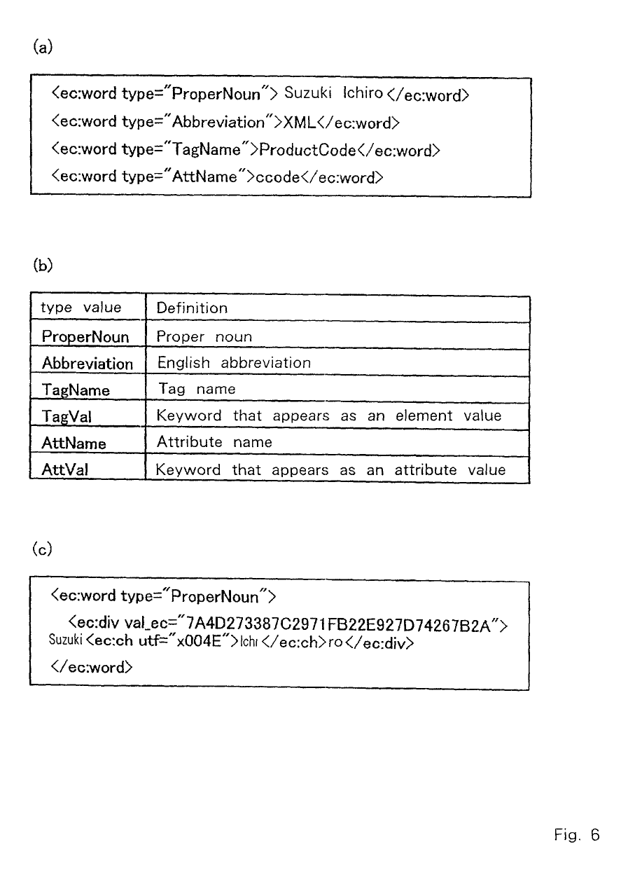

FIGS. 6A to 6C are diagrams showing example information provided for the OCR context process module. Tags provided for the context process module are shown in FIG. 6a, and definitions for attribute types are shown in FIG. 6B, while in FIG. 6C, information is added by using methods (1) and (2). As is shown in FIG. 6B, the meaning of a word is added as information; for example, type value “ProperNoun” means “proper noun”, and “Abbreviation” means “English abbreviation”. In the example in FIG. 6A, tags are employed to clearly indicate that “Suzuki Ichiro” is a “proper noun”, that “XML” is an “English abbreviation”, that “ProductCode” is a “tag name”, and that “ccode” is an “attribute name”.

As is described above, generally, when new words, such as the latest technical terms, appear often, it is difficult for an OCR system alone to cope with them. However, in this embodiment, since new words or special words are added to a document using XML tags, an OCR system that has read these tags can employ this information for character recognition. That is, in the context process module, these data can be used to improve the recognition ratio not only for one document, but also for other documents.

The above descriptions may be added to the application data read from printed paper and input by an OCR system, and may be transmitted as electronic data. Or, the descriptions may be manually input by a person in charge. When the data is printed on paper, as is shown in FIG. 6C, methods (1) and (2) can be used to replace characters that may cause errors, or to add error correction information. In this example, it is clearly stated that the error correction information is a “proper noun”, and that the character “ˆ ê”, which tends to be misread, is a Chinese character that, together with the correction code, is used for “Suzuki Ichiro”.

A description that is added to resolve the problem in the above described manner may be erroneously re-input during the OCR scanning process or during the transmission process. However, because of the following reasons, (1) to (4), it is felt that the possibility this will occur is sufficiently less than is the possibility that an error will occur in the application data description portion.

(1) The character types used in the above descriptions, (1), (2) and (3), are limited to alphanumeric characters and partial symbols. Further, a character string that may be written about the element name and the attribute name and value is known in advance, and an increase in the accuracy of the context process can be expected.

(2) A symbol, such as a full sized symbol, that may be incorrectly converted does not appear in the descriptions in (1) to (3).

(3) Since the number of characters is generally smaller than that which is required for the application data description, the possibility is high that the entire character string will be correctly recognized.

(4) Additional error correction information can be added to the description provided as error correction information.

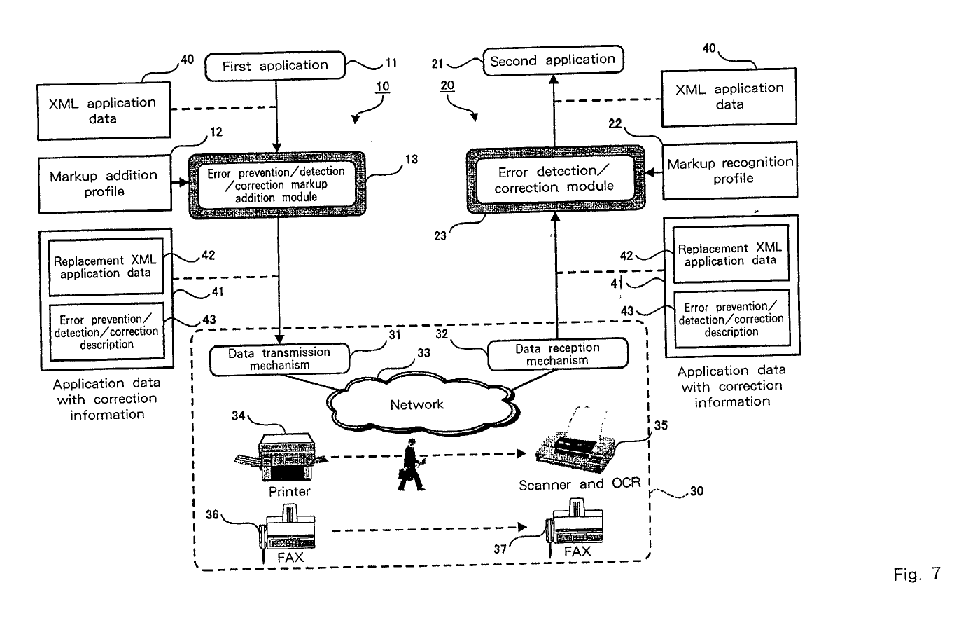

The specific configuration of a system according to this embodiment that is used in order to implement the above methods will now be described. FIG. 7 is a diagram for explaining the general configuration of an error correction support system according to the embodiment. In this example, XML application data 40 is exchanged by a first application 11, consisting of a first computer 10 operated in one environment, and a second application 21, consisting of a second computer 20 operated in a different environment, i.e., the XML application data 40 is transmitted by the first application 11 to the second application 21, for which the operating environment differs.

The first computer 10 comprises: a markup addition profile 12 and an error prevention/detection/correction markup addition module 13, for performing a process while referring to the markup addition profile 12, and may include a data transmission mechanism 31. The second computer 20 comprises: a markup recognition profile 22 and an error detection/correction module 23, for performing a process while referring to the markup recognition profile 22, and outputs the second application 21. In addition, a data reception mechanism 32 may be included, and the data transmission mechanism 31 and the data reception mechanism 32 may be constituted by other modules.

A data transmission unit 30 employs the data transmission mechanism 31 of the first computer 10 and the data reception mechanism 32 of the second computer 20 to transmit data via a network 33. Further, data printed by a printer 34 in the first computer 10 may be transmitted manually or by mail, and may be read by a scanner and OCR 35 at the second computer 20. Furthermore, data that is printed by the first computer 10 may be read by a facsimile scanner 36, and output by a facsimile printer 37 via a telephone line, or, of course, data may be transmitted by facsimile without being printed by the first computer 10 and/or the second computer 20. The data transmission unit 30 may be a B2B (business-to-business) server that automatically connects an application to a transport layer, or it may be implemented by a manual cut and paste operation (or by using OCR). In addition, data may be exchanged across the Internet via various systems that have different code types. Therefore, the data transmission unit 30 can be regarded as a portion wherein the contents are unknown, i.e., a portion wherein various fallback scenarios could be present.

Characters in application data that should be replaced by tags, portions that contain error detection/correction code that should be calculated, and information concerning whether correction code information should be inserted into the application data or should be added at the end of data using the XPath are written in the markup addition profile 12, which the error prevention/detection/correction markup addition module 13 refers to while performing the processing. During this processing, the XML application data 40 is partially altered to obtain replacement XML application data 42, to which several error prevention/detection/correction descriptions 43 are added in order to generate the application data 41 that includes correction information.

The application data 41 that includes correction information (the replacement XML application data 42 and the error prevention/detection/correction description 43) and that is generated by the first application 11 at the first computer 10, is transmitted to the second computer 20 by the data transmission unit 30. That is, as previously described, the data 41 is transmitted by the data transmission mechanism 31 to the transmission means, such as a network 33 (HTTP or SMTP), the FAX scanner 36 or a postal service, and is received at the second application 21 via the data reception mechanism 32.

Based on the markup recognition profile 22, the error detection/correction module 23 on the data reception side, which is positioned between the second application 21 of the second computer 20 and the data reception mechanism 32, analyzes the application data 41 that includes correction information, and detects or corrects errors (or as needed, requests manual correction). After the correction process has been completed, the error detection/correction module 23 deletes the detection/correction tags and attributes, corrects the tags, forms spaces, for example, and recovers the XML application data 40.

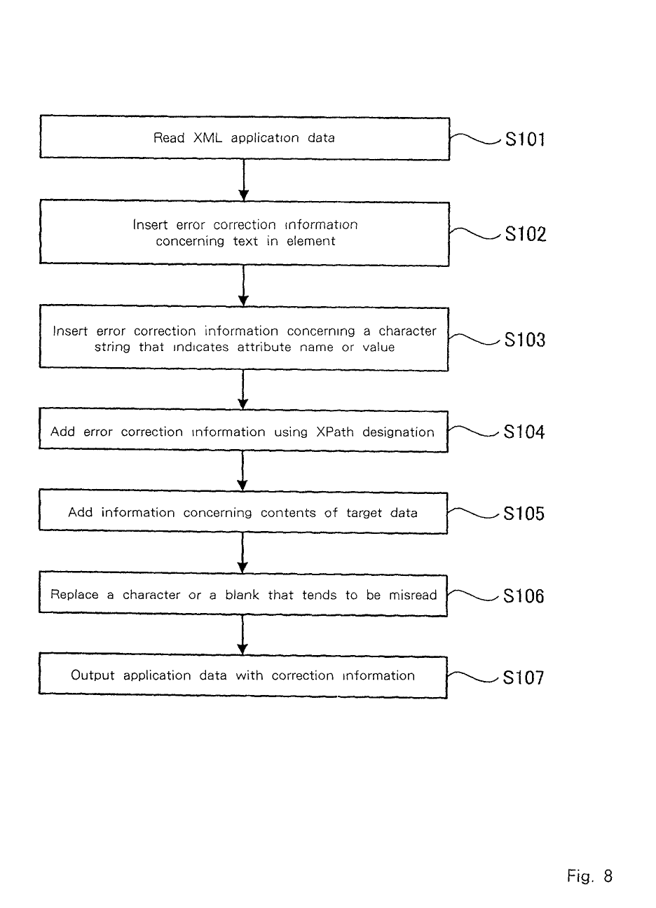

FIG. 8 is a flowchart showing the processing performed by the error prevention/detection/correction markup addition module 13 at the first computer 10. First, the error prevention/detection/correction markup addition module 13 reads the XML application data 40 (step 101), and develops the data 40 to prepare an internal data form, such as a DOM (Document Object Model). Then, error correction information concerning the text in the element is inserted (step 102), and error correction information concerning a character string that represents the name and value of an attribute is inserted (step 103). Thereafter, error correction information is added by designating the XPath (step 104), information concerning the contents of target data is added (step 105), and characters and blanks that are easily misread are replaced (step 106). After the correction information has been added, the application data 41 that includes correction information is output (step 107). In this embodiment, the XML data is handled as a shaped form.

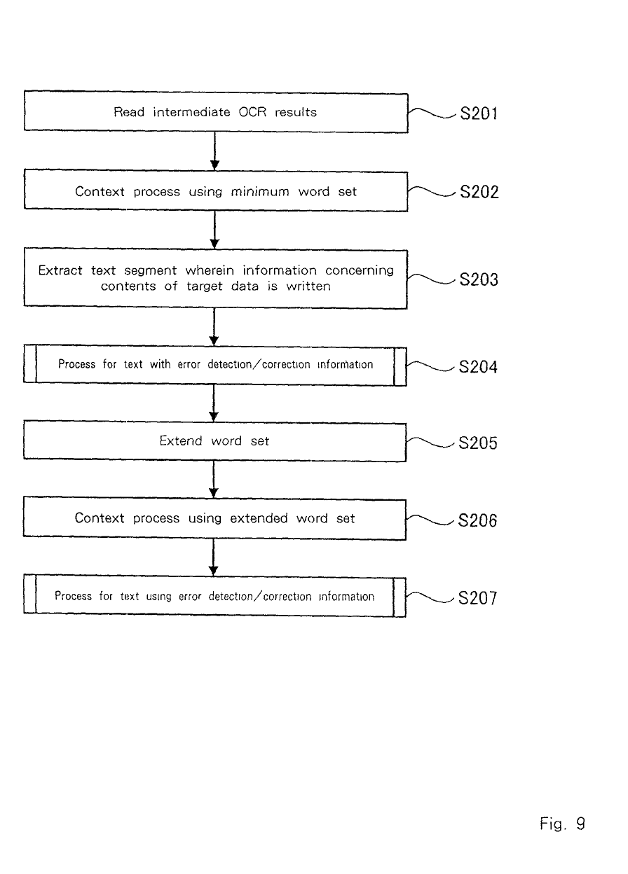

FIG. 9 is a flowchart showing the processing performed by the error detection/correction module 23 of the second computer 20 when OCR is used to re-input data printed on paper. First, the error detection/correction module 23 reads the intermediate result obtained for a text file that is read using OCR or that is input manually (step 201). The intermediate result is OCR text to which information for the second and following recognition choices has been added.

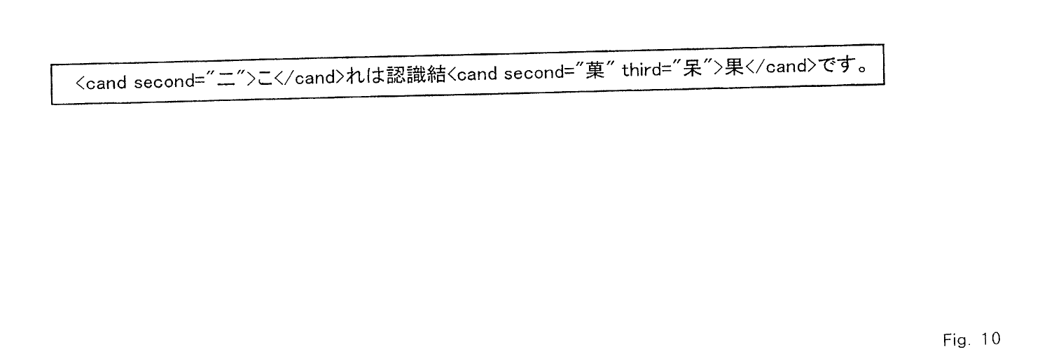

FIG. 10 is a diagram showing the intermediate results written on the XML base. In this example, the second and third choice information is added for “ko” and “ka” in the character string “kore wa ninshiki-kekka desu (this is the recognition result). The manually input text can be regarded as intermediate results constituted by only the first choice. For manually input text, so long as the information that characters are easily misread as other characters is well known, based on that information, the second and third choice information may be added.

Referring again to the flowchart in FIG. 9, using a minimum word set, the context process is performed for the intermediate results obtained at step 201 (step 202). During the context process, the text, as intermediate OCR results is divided into basic phrases/words, and a check is performed for each of these words to determine whether it is registered in a dictionary. If the word is not registered, a check is performed to determine whether a chosen replacement can match a registered word when a first character choice is replaced by a second or following character choice. If it is ascertained that the chosen replacement will match, the first character choice is replaced by the other character choice, and since an algorithm has already been established for the context process, the conventional algorithm is mounted. The word dictionary is a common Japanese dictionary that includes tag information (minimum word sets) defined for this embodiment using the methods (1) to (3).

Then, the text segment wherein information concerning the contents of target data is written is extracted (step 203). That is, a description using the <word> tags for method (3) and the following description for the correction code are extracted from the text obtained after the first context process is performed. Thereafter, the text to which the error detection/correction information has been added is processed (step 204). Proper nouns and tag information inherent to the application are extracted from the processing results, and are added to the word dictionary used for the context process, thereby expanding the word set (step 205). When the DTD or a scheme concerning the application data is provided, information concerning the character string that can appear as the tag name and the name and value of the attribute can be extracted, and can be added to the dictionary. Thereafter, the context process is again performed by using the dictionary to which the words have been added (expanded word set) (step 206). Then, the entire text segment, along with the error detection/correction information, is processed (step 207), and the processing sequence for the error detection/correction module 23 is terminated. When this processing is employed for general document input support, steps 201, 205 and 206 constitute the processing. Further, to cope with incorrect character conversion, steps 201 to 206 can be eliminated.

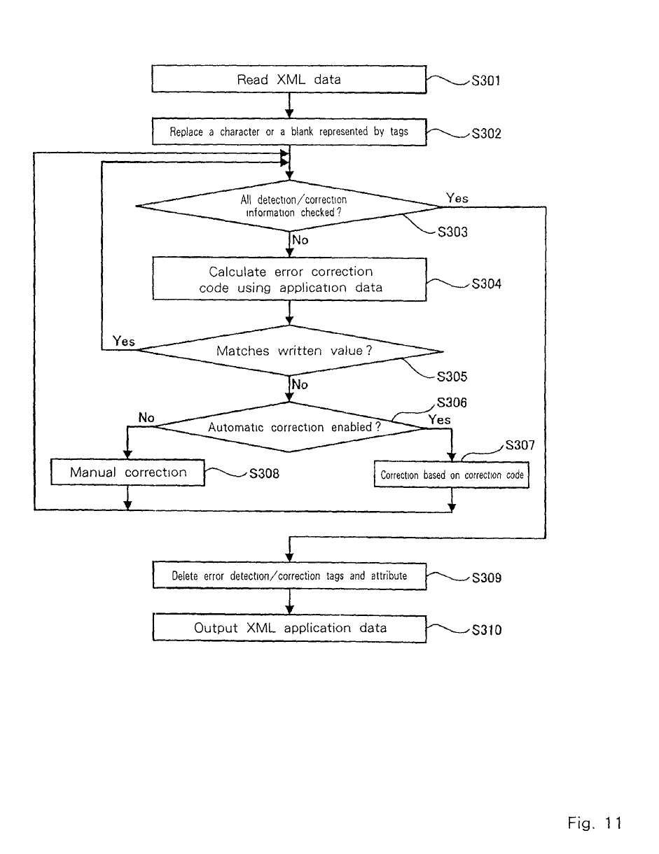

FIG. 11 is a flowchart showing an overview of the processing performed at steps 204 and 207 in FIG. 9 for text to which error detection/correction information has been added. First, the XML data is read (step 301) and the XML text is developed to obtain an internal data form, such as the DOM (Document Object Model). When the XML text does not have a shaped form, it is manually corrected based on an error message. Then, the replacement of the character or the blank with tags, or the recovery from the tags, is performed as is described by method (1) (step 302). Following this, a check is performed to determine whether all the detection/correction information has been examined (step 303). When all the information has not been examined, a correction code is calculated, using the application data, for each description of the error correction code written using the above mentioned method (2) (step 304). A check is then performed to determine whether the correction code obtained by the calculation matches the value in the description (step 305). When the two match, program control returns to step 303.

When, at step 305, the two values do not match, a check is performed to determine whether automatic correction has been enabled (step 306). If automatic correction has been enabled, a correction is performed based on the correction code (step 307). Whereas if automatic correction has not been enabled, manual correction is performed (step 308) and program control returns to step 303. This process is repeated until, at step 303, it is determined that all the detection/correction information has been examined and the error detection/correction tags and attributes are deleted (step 309) and the original XML application data 40 is output (step 310).

Four application examples of the use of this embodiment will now be described.

Application example 1) Storing, on paper, data to which is affixed a signature for a small company or the signature of an individual user.

For example, a situation wherein documentary evidence must be stored so that a common user can submit it as needed is presented for B2B or B2C (business-to-Consumer) electronic commerce, or for an electronic application submitted to a public organization. The documentary evidence is, for example, an order slip forwarded by a buyer, a receipt for shopping performed via the Internet, or a receipt for a tax report. The application example 1 is an example fallback scenario for which paper is used, wherein a user receives electronic documentary evidence and prints it on paper. On this paper,

application data (information for an order slip or a receipt)

a signature for the application data (or a part of it)

a description of the method (1), (2) or (3) used for the re-input support are printed as text with added XML tags.

When evidence confirmation is required, the user submits the paper that is stored, or its copy. An organization (a credit company, a tax office, etc.) that has received the evidence paper re-inputs the XML text on the paper using the method of the embodiment, and examines the signature. The re-input operation may also be performed by a user who stored the documentary evidence or a service provider that provides only a data input service.

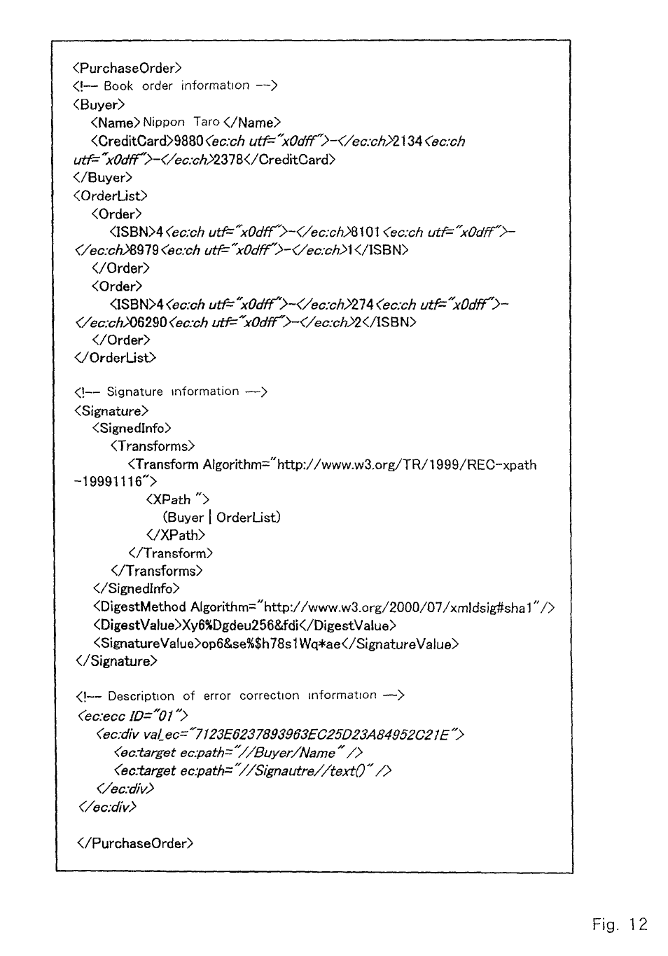

FIG. 12 is a diagram showing example XML data in application example 1. Portions in italics are information concerning error prevention/detection/correction. As is shown in FIG. 12, “− (minus)”, which tends to be misread, is replaced by book order information, and for signature information, error correction information is collectively written at the end. In this example, error correction code is generated for “Nippon Taro”, who is a buyer, and “Xy6%Dgdeu256&fdi” and “op6&se%$h78slWq*ae”, which are digest information and signature information.

According to the embodiment, as in application example 1, the same signature target data as the original electronic text can be reproduced. The information, such as the number of blanks and characters having the same shape, that it is difficult to identify once it has been printed on paper (but that affects the determination of the identification of the signature) can be correctly re-input. Generally, when the verification of a signature on re-input data fails, a check is performed to determine whether the data has been altered, or if the failure is caused by an error that occurred during the re-input of data. When the failure is due to an error that occurred during the re-input of data, the process for ascertaining the location of the error and correcting it must be manually performed. When this embodiment is employed, the human labor that is required can be reduced and the operation, which takes much time, can be simplified considerably.

Whether an application, such as for electronic commerce or an electronic application, is established depends greatly on how many small entities or individuals will participate in it. For even when small entities or individuals employ web browsers for electronic commerce or for electronic applications, usually they do not have a system for processing and storing electronic forms or evidence, and can not afford the operating costs for one. However, if the embodiment ensures that the forms and the evidence will be output on paper, and that the data can easily be re-input and expressed electronically, small entities or individuals can process or store documents on paper in the conventional manner. While it frequently happens that order slips electronically issued for a business transaction are dispatched to small entities by facsimile, by using the method of the embodiment, probative force can easily be imparted to the order slips so that the data can be verified.

Application example 2) Replacement of part of an electronic work flow.

Electronic work flow smoothes the flow of information between/in companies, and provides an advantage, such as a reduction in clerical costs and in turnaround time. However, when one of the companies/departments in the work flow path can not fully cope with electronic operations, the succeeding organization must input data again, or must process all the succeeding processes on paper. In the work flow wherein multiple independent organizations (departments and entities) are involved, the electronic levels of the processes performed by the organizations differ, so that the electronic work flow and the paper-based work flow tend to coexist. This is because the organizations individually develop and update their systems, and how much they make on the electronic operations also differs. For an organization that must collectively process transactions received from multiple other organizations, electronic transactions are important; however, the number of transactions is not so large for individual organizations that issue the forms, so that the priority for an electronic transaction may be low.

In application example 2, the company/department A, which is located before company/department B that accepts only a paper based form, prints, on paper, the data form that the company/department A electronically processed, and transmits the printed paper to the succeeding company/department B. On this paper,

data form

a signature for (a part of) form data, if necessary

the description of re-input support explained using methods (1), (2) and (3) are printed as XML tagged text. XML form data that are rendered in a form that a person can more easily understand (e.g., a table form) may be attached.

Upon the receipt of the paper form, the company/department B performs a process based on the printed information, and transmits the results to the succeeding company/department C. At this time, the company/department B transmits, to the company/department C, not only the form prepared by the company/department B (including the information that the company/department B corrected or added), but also a copy of the paper form received from the company/department A. Upon the receipt of the paper form, manually or by using OCR the company/department C re-inputs the information printed on the paper form by the company/department A. At this time, the function of this embodiment can be employed to automatically detect and correct input/recognition errors. Support using the function of the invention can not be employed for the input of data on a form prepared by the company/department B. However, since the amount of information to be input is smaller than the form data received from the company/department A (the information received from the company/department A serves as a summary of the information that the companies/departments that have so far been concerned have added/corrected), the load imposed on the input side is expected to be small. After the company/department C, the form data are distributed and processed again along the electronic work flow.

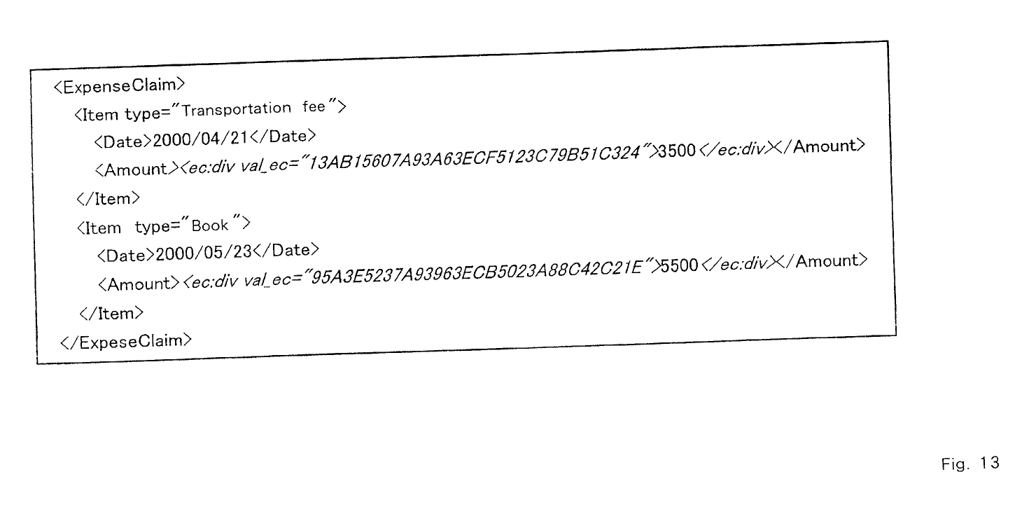

FIG. 13 is a diagram showing example XML data in application example 2. The portions in italics contain information concerning error prevention/detection/correction. In this example, values “3500” and “5500” are written in for “transportation fee” and “books”, and the error correction code is calculated for character strings that correspond to these fees. By using the error correction codes, an error that occurs during the re-input of text printed on paper can be automatically detected, and the number of errors that occur during the re-input of information important to a following operation can be reduced.

Application example 3) Document input support.

There is a demand for the electronic use of one part or all of a document (not limited to XML text) that is distributed only in printed paper form. The latest OCR systems can read a printed document with an accuracy of (95 to 99% or higher) when all conditions for the scanning resolution, for example, have been satisfied, and can thus be used as primary input means. A problem that occurs and that necessitates the manual correction of the results output by an OCR system is the presence therein of technical terms and of proper nouns for which context processing can not be performed. Since the recognition accuracy for these terms is low, and further, since a specific term may frequently appear only in one document, a heavy load is imposed on the correction side. Terms such as these terms tend to be available only in special magazines, manuals and job specific specifications.

In application example 3), a person in charge of data input scans a target document in advance or performs a partial OCR process, to identify technical terms and proper nouns such as are described above, and uses method (3) to describe the terms. Unlike in the two previous examples, these descriptions are electronically prepared by a text editor. Since the intermediate OCR results and these descriptions are processed together, automatic error detection and correction can be easily performed for technical terms/proper nouns for which human labor is required for checking and correction. In application example 3), both XML tagged text and general non-tagged text can be employed.

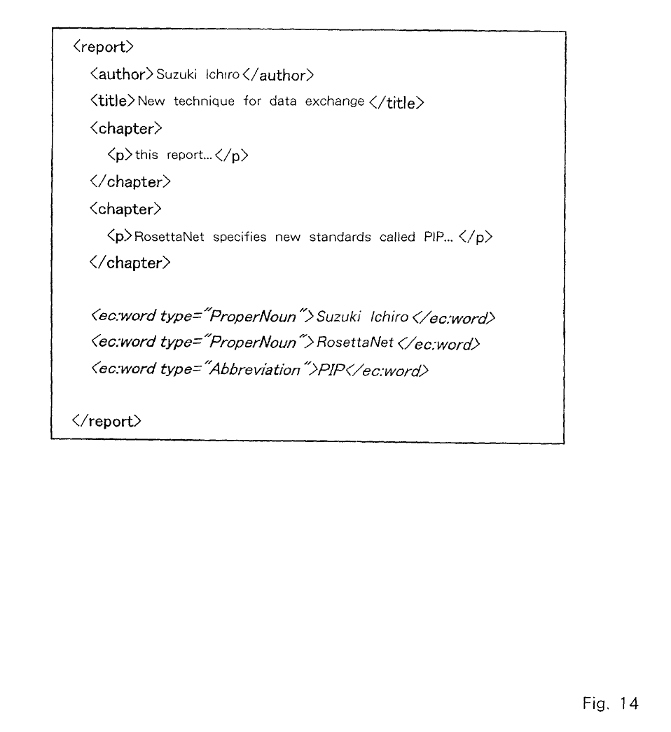

FIG. 14 is a diagram showing example XML data for application example 3). The portions in italics contain information concerning error prevention/detection/correction. In this example, correction information is added for proper nouns “Suzuki Ichiro” and “RosettaNet”, and the English abbreviation “PIP”.

Application example 4) Coping with incorrect conversion

When the error correction function is not only supported for the re-input of data printed on paper, but also for the transmission of data at the system level (transport layer), the method of this embodiment is effective for performing error correction at a document exchange layer or an application layer that is located at a higher level. The process used in application example 4) to cope with incorrect conversion is an example method.

In application example 4), an XML data creator employs the above methods, (1) and (2), for text for which incorrect conversions should be prevented, prepares and adds information for detection/correction of incorrect conversions, and electronically transmits the information to another user via multiple intermediates (systems and persons). Before transmission, a character (one part of symbols) that tends to be incorrectly converted is converted into an expression that will not be incorrectly converted. And if incorrect conversion occurs during the intermediate process, this can be corrected using error correction information, or a warning can be issued before the data is processed by an application program.

As is described above, according to the embodiment, an expression, such as blank continuity or a commonly shaped character, that visually will be mistakenly identified, can be exchanged for another form in advance, before being transmitted, and errors that occur during the re-inputting of text printed on paper can be automatically detected and/or corrected. Further, examinations performed by human beings can be eliminated for portions of printed text that are correctly re-input. In addition, another form can be used for the transmission of characters that tend to be incorrectly converted, and incorrect conversions can be easily and automatically detected and/or corrected. It is anticipated that these results can be obtained both by manually re-inputting data printed on paper and by providing support for OCR.

In this embodiment, a replacement scenario (fallback) using paper can be prepared and carried out for the data exchange, storage and processing performed in an electronic work flow. But although the prevailing opinion is that electronic manipulation of documents and of forms is the trend of the future, so long as an application scenario is not established for electronic operations and is not employed for all the aspects of the work flow, the companies/departments that will be able to follow this trend will be limited. The preparation of an appropriate replacement scenario, as in this embodiment, is meaningful for the promotion of electronic operations involving documents/forms. Further, the Japanese profile recommends that UTF-8 or UTF-16 be used for the exchange and storage of XML data. However, in actuality, a variety of encoding methods, such as Shift JIS or Japanese EUC (End User Computing), are employed, and a table for handling conversions between these systems has not been uniquely determined. When a tie-up with a legacy system (a conventional system) is initiated, a conversion relative to Japanese EBCDIC (Extended Binary Coded Decimal Interchange Code) that is mounted differently, depending on the vendor, is also required. In this embodiment, since the data description is prepared for the prevention/detection and correction of incorrect conversions, while assuming an “incorrect conversion will occur somewhere”, constant effects can be obtained without depending on the establishment of data exchange specifications to prevent incorrect conversions.

As is described above, according to the present invention, errors and incorrect conversions can be detected that tend to occur during the re-input of text that is written in a description language for which markups are used to describe data or sentences.

It is to understood that the present invention, in accordance with at least on presently preferred embodiment, includes a process for defining a tag set to prevent errors and incorrect character conversions that tend to occur during the re-input of text that is included in application data written in a markup language; and a process for adding, to a predetermined portion of application data, replacement information using said tag set and/or correction code based on a predetermined algorithm. Together these elements may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. An error correction support method for application data written in a markup description language, said method comprising the steps of:
defining a tag set to prevent errors or incorrect character conversions that occur frequently during the re-input of text; and
using a tag set to add rewritten information to a predetermined portion of said application data.

2. The error correction support method according to claim 1, wherein said tag set is defined for at least one of a character in the same shape, a similar character, a space or a character having a complicated shape.

3. The error correction support method according to claim 1, wherein said markup description language is XML (Extensible Markup Language).

4. An error correction support method for application data written in a markup description language, said method comprising the steps of:
selecting, from elements of said application data, a text portion that needs error correction support;
enclosing said selected text portion using predetermined tags; and
writing correction code, which is based on a predetermined algorithm, in said text portion enclosed by said predetermined tags.

5. The error correction support method according to claim 4, wherein said correction code is calculated for a character string that represents an attribute value or an attribute name, and is written using a predetermined attribute for the description of an error code.

6. An error correction support method for application data written in a markup description language, said method comprising the steps of:
selecting, from elements of said application data, character strings that require error correction support;
generating, for said selected character strings, error correction codes that are is based on a predetermined algorithm; and
writing said error correction codes as nodes for said application data.

7. The error correction support method according to claim 6, wherein said error correction codes are generated for all multiple character strings that are selected, and are added after predetermined elements of said application data have been written.

8. An error correction support method for application data written in a markup description language, said method comprising the steps of:
sorting, into predetermined attribute types, words in said application data that may constitute barriers in a context process;
writing said attribute types to said application data using a predetermined tag set; and
transmitting or storing said application data with which said attribute types are included.

9. The error correction support method according to claim 8, wherein said words that are sorted into said predetermined attribute types and that may constitute barriers in said context process is at the least one of a set comprising proper nouns, alphabetic abbreviations, tag names, keywords that appear as element values, attribute names, keywords that appear as attribute values.

10. A computer system which generates application data in a markup description language, said system comprising:
a markup addition profile, which includes information used for replacing a predetermined portion of said application data with tags and/or information for calculating error detection/correction code for said predetermined portion;
a markup addition module, for replacing, by referring to said markup addition profile, said predetermined portion with tags, and/or calculating said error detection/correction code for said predetermined portion, and for adding to said application data, to generate application data using correction information, said tags and/or said error detection/correction code; and
an outputter which outputs said application data with correction information that is obtained by said markup addition module.

11. The computer system according to claim 10, wherein said markup addition profile includes information used to insert said error detection/correction code into said application data, or information used to add said error detection/correction code as an annotation at the end of said application data.

12. A computer system which generates application data in a markup description language, said system comprising:
an inputter for entering application data with replacement information in a predetermined text portion that can be replaced by tags;
a recognizer which recognizes said replacement information included in said application data that is entered by said inputter; and
an error detector/corrector which replaces with text information for the expression of said tags of said replacement information that is recognized by said recognizer.

13. A computer system which generates application data in a markup description language, said system comprising:
an inputter which enters application data, including correction code generated for a predetermined text portion;
a recognizer which recognizes said correction code, entered by said inputter, that is included in said application data; and
an error detector/corrector which calculates said correction code recognized by said recognition means and which compares said correction code with a text portion.

14. The computer system according to claim 13, wherein, when said correction code does not match said text portion, said error detector/corrector determines whether automatic correction is possible; and wherein, when said automatic correction is determined to be possible, said error detector/corrector, based on said correction code, corrects said text portion and outputs said resultant application data.

15. A computer system, which generates application data in a markup description language, said system comprising:
an inputter which inputs text information;
a context process module which compare a word dictionary and individual character recognition results obtained from said text information, and which detects or corrects an error; and
a word information recognizer which recognizes tags inputted with said text information to recognize word information that are not included in said word dictionary,
wherein said word information is provided to said context process module.

16. A computer system which generates application data in a markup description language, said system comprising:
a selector which selects from original application data, a word that may constitute a barrier in a context process that, to detect and correct errors, compares characters to be recognized with entries in a word dictionary;
a descriptor which uses tags to write error correction code for said word that is selected by said selector; and
an outputter which adds to said application data said error correction code that is written by said descriptor and which outputs said application data with said error correction code.

17. An application data provision system, wherein a second computer reads application data generated by a first computer using a markup language; wherein said first computer defines a tag set to detect an error or an incorrect character conversion that tends to occur when text is re-input at said second computer, adds said tag set to said application data, and outputs the resultant application data with correction information; and wherein said second computer receives said application data with said correction information, recognizes said tag set that is included in said application data, and detects and/or corrects an error or an incorrectly converted character in said application data.

18. The application data provision system according to claim 17, wherein said second computer receives, from said first computer, said application data including correction information that is printed on a paper-based document or form.

19. An application data provision system, wherein a second computer reads application data generated by a first computer using a markup language; wherein a first computer employs tags to write additional information concerning predetermined text, and outputs said additional information with application data; wherein a second computer includes a context process module for detecting and correcting error by comparing individual character recognition results with entries in a word dictionary; and wherein said second computer receives, from said first computer, said application data and said additional information, and employs said additional information that is received to update said entries in said word dictionary of said context process module.

20. A storage medium on which a computer stores a computer-readable program that permits said computer to perform:
a process for defining a tag set to prevent errors and incorrect character conversions that tend to occur during the re-input of text that is included in application data written in a markup language; and
a process for adding, to a predetermined portion of application data, replacement information using said tag set and/or correction code based on a predetermined algorithm.

21. A storage medium on which a computer stores a computer-readable program that permits said computer to perform:
a process for recognizing a tag set that encloses replacement information, and/or a correction code, to prevent errors or incorrect character conversions that tend to occur during the re-input of text information that is included in application data written in a markup language; and
a process for employing said tag set to replace predetermined text information in said application data.

22. A program storage device readable by machine, tangibly embodying a program of instructions executable by the machine to perform an error correction support method for application data written in a markup description language, said method comprising the steps of:
defining a tag set to prevent errors or incorrect character conversions that occur frequently during the re-input of text; and
using a tag set to add rewritten information to a predetermined portion of said application data.
